(19) United States
(12) Patent Application Publication
(10) Pub. No.: US 2005/0010882 A1
(43) Pub. Date: Jan. 13, 2005

(54) Method and device for creating a model of a circuit for the formal verification

(76) Inventors: Klaus Winkelmann, Riemerling (DE); Jorg Bormann, Pullach (DE)

Correspondence Address: BRINKS HOFER GILSON & LIONE, P.O. BOX 10395, CHICAGO, IL, 60610, US

(21) Appl. No.: 10/855,856

(22) Filed: May 27, 2004

(30) Foreign Application Priority Data
Jun. 5, 2003 (DE) DE 103 25 513.3

(51) Int. Cl. G06F 9/45; G06F 17/50

(52) U.S. Cl. 716/5

(57) ABSTRACT

For the simplified creation of models of a circuit for the formal verification of the same, it is proposed to provide a valid first model (a) for example from a simulation of the circuit (2) and to generalize this valid first model through modification (3), whereby after the modification it is checked whether the modified model still describes an actual behavior of the circuit (4). In this case, the modified model is provided as a model of the circuit for the formal verification of the same (5).

### CLAIM FOR PRIORITY

Applicants claim priority under 35 U.S.C. §1.119 to German Application DE 103 25 513.3, filed on Jun. 5, 2003.

### BACKGROUND

The present invention relates to a method and device for creating a model of a circuit for the formal verification of the same as well as a corresponding computer program product and a corresponding electronically readable data medium.

Designs for circuits as, for example, user-specific integrated circuits such as Application Specific Integrated Circuit (ASIC) must be checked intensively, since the build-up time of the production is lengthy and expensive. Each repetition, which becomes necessary as the result of faulty performance, costs a great deal of money, delays the launch of the product on the market and also affects other design projects, since it retards the time schedules of the development engineer and product testing teams. An additional work phase for verification of the circuit design is therefore contained in the design process, which represents about 60% to 80% of the entire design time for a new ASIC.

In the verification process concentration is focused on checking for correct functionality of the circuit being tested. The basis of this is an RTL (Register Transfer Level) description of the circuit, which equates to a machine-readable representation of the circuit, for example. With this description, verification can take place by way of simulation. Here, however, the problem arises that the speed of the finished circuit and of the simulation differs by a factor of 1,000,000. Therefore, in this case it is improbable that errors, which only occur sporadically, for example in intervals of several hours, are detected.

Therefore methods are sought which permit faster and more critical testing of the RTL description. For this purpose, formal methods are an option. With the aid of mathematical methods it is checked whether a model, describing at least one aspect of the desired functionality of the circuit, is compatible with the representation of the circuit through the RTL description.

A model describes a causal connection between properties by means of the value curve of quantities or signals over time. It describes assumptions about the temporal distribution of signal values and assurances about further signal values and their temporal relation to the signal values of the assumption. A model is a valid or true model of a circuit if the operation of the circuit can only produce value curves. In this case the assurances are satisfied, whenever the assumptions are fulfilled. The validity of a model can be proven in particular with algorithms of the formal verification. A category of such algorithms is called “Property Checker” and in this connection a model is also designated as “Property”. The Property Checkers work, as though they would simulate the circuit with each possible input sample and simulate the validity of the model on each possible input sample and check the validity of the model on each of these simulation results.

General information about formal verification of circuits can be found, for example, in T. Kropf, Introduction to Formal Hardware Verification, Springer Verlag, 1999 or in J. Bormann, C. Spalinger, Formal Verification for Non Formalists, IT+TI Information Technology and Technical Computer Science, 43(1), 2001.

A problem with the formal verification of electronic circuits or systems as for example ASICs remains the creation of a model, which describes the desired functionality, that is to say a formal specification. Finding the correct content of such a model is a time-consuming task and at present is the most serious obstacle to quick application of existing technology for the formal verification on a large scale. So far, such models are created in accordance with a manual trial and error process. The verification engineer expresses an aspect of the model using a formal language or similar physical means such as state automations. The engineer then checks the model and modifies it until a valid model is obtained. In the frequent event of failure (the model does not prove valid and/or true), the engineer analyses the design of the circuit and decides whether the model must be changed, or whether a failure of the circuit has been traced. In this case, the verification engineer uses knowledge from the specification of the circuit and the HDL (Hardware Description Language) RTL description.

It is therefore an object of the present invention to provide a method and/or a device, as the result of which the creation of such a model is accelerated and simplified.

### SUMMARY OF THE INVENTION

According to the invention, a method is proposed for creating a model of a circuit for the formal verification of the same, which comprises the following steps:

a) Provision of a valid first model, which describes an actual behavior of the circuit,

b) Generalization of the valid first model by modification of the same, in order to obtain a second model of the circuit, whereby the second model has a higher degree of abstraction than the first model with regard to the description of the circuit, and

c) Check whether the second model is a valid model of the circuit, whereby the second model is recognized as a valid model of the circuit, if the second model describes an actual behavior of the circuit and in this case the second model is provided as the model of the circuit for the formal verification of the same.

By providing a valid first model, it is not necessary to start at zero for creating the model. This valid first model can be obtained in particular from a simulation of the circuit. Therefore a very special model, which is generalized by the method according to the invention is obtained from the simulation. The circuit can be described for execution of the simulation in a suitable hardware description language.

The true first model and accordingly also the second model of the circuit derived from it can describe a behavior of the circuit over a specific period, in particular in discrete time steps. The first model and also the second model can contain as well as input quantities both output quantities and internal quantities of the circuit. Properties of the model, as for example these quantities, are in this case preferably categorized as assumptions, assurances and irrelevant properties. The valid first model can then be modified, by the category of at least one of these properties being changed at least once. Alternatively or additionally the specific period can be limited.

The check in step c) of the method according to the invention can take place in particular by the validity of the second model being proved or disproved through formal verification.

If the second model is recognized as true, steps b and c) can be repeated with the second model as a new first valid model, in order to obtain a further model of the circuit. If, however, the second model proves invalid, steps a) to c) can be repeated with the same first valid model, whereby in the case of step b) another modification of the first model takes place. Alternatively or additionally a design error of the circuit can be present in this case and therefore traced (automatically).

The execution of the method can in particular be computer-aided, whereby step c) can be carried out automatically, while step b) can be performed by a user. In support of step b) the first model and the second model can in particular be graphically represented and the first true model can be modified by means of a graphic user surface.

Step b) can also, however, be performed at least partly automatically.

Altogether, an efficient method and corresponding device are therefore made available, as the result of which a model of a circuit can be provided for the formal verification in a simple and time-saving way.

### BRIEF DESCRIPTION OF THE DRAWINGS

The invention is described below in detail with reference to the appended drawing on the basis of preferred embodiments, wherein:

FIG. 1 is a block diagram of a preferred embodiment of a device according to the invention,

FIG. 2 is a flow chart of a preferred embodiment of the method according to the invention, and

FIGS. 3A to 3C are graphic representations of individual steps of the method according to the invention.

### DETAILED DESCRIPTION OF THE DRAWINGS

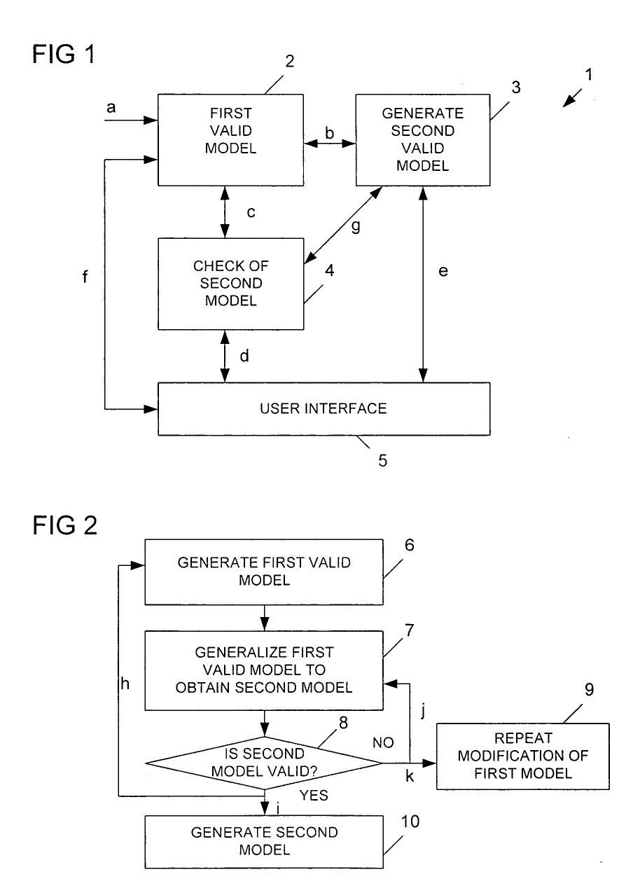

In FIG. 1, an embodiment of a device according to the invention is schematically illustrated. In this case, the device is provided on a computer or a data-processing system 1. A first unit 2 serves to provide a valid first model of the circuit, which is to be checked by means of formal verification. This circuit can for example be a user-specific integrated circuit (ASIC).

This valid model can originate for example from a simulation of the circuit as mentioned at the beginning of the description and be handed over to the first unit 2 as indicated by an arrow a. The first unit 2 communicates with a second unit 3 for generalizing the valid first model by modification of the same as indicated by an arrow b. As a result of this modification, the second model has a higher degree of abstraction than the first model with regard to the description of the circuit. The second unit 3, which communicates with the second unit 3 via a user interface 5 as indicated by arrow e, can obtain from a user the information, as to how the valid first model is to be modified. For example, the user can decide to remove one or more input quantities of the valid first model in order to obtain the second model. In addition, the user can also influence the provision of the valid model in the first unit 2 via the user interface 5 as indicated by arrow f, for example by selection of a simulation.

Furthermore, a third unit 4 is provided for checking the second model, whereby the third unit 4 is configured in such a way that it recognizes the second model as a valid model, if the second model describes actual behavior of the circuit. Communication of the third unit 4 with the first unit 2 and the second unit 3 is indicated by arrows c and/or g.

The result of this examination can be communicated to a user via the user interface 5, as indicated by an arrow d.

Units 2-5 are preferably realized in terms of software by means of suitable software modules after installation of a corresponding data medium or computer program product, although naturally in principle they can also be realized by means of hardware.

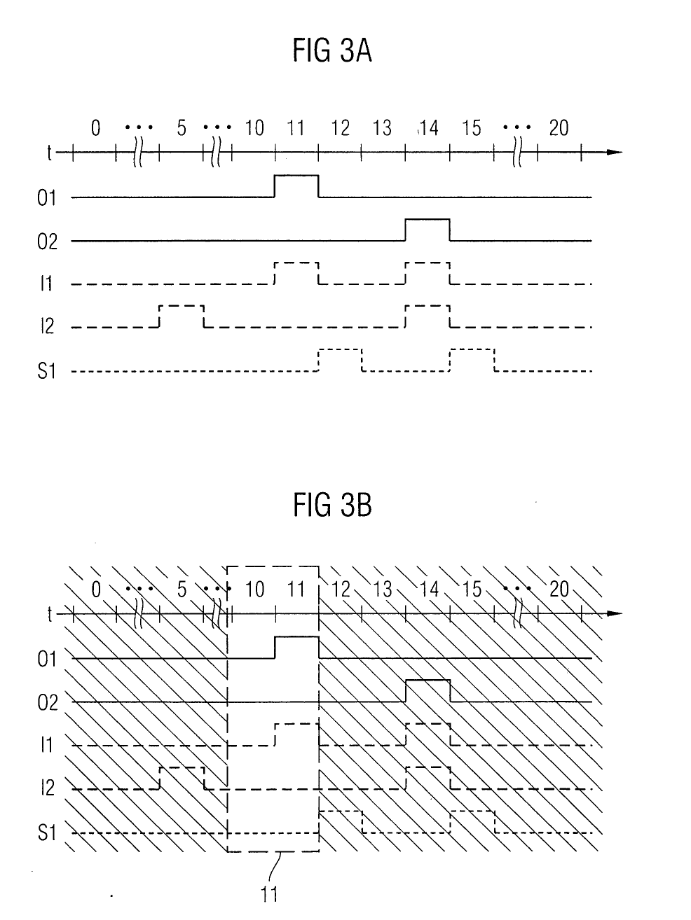

In FIG. 2 the sequence of a method for creating a model of a circuit, as it can be implemented by means of the device illustrated in FIG. 1 for example, is described in the form of a flow chart.

In step 6 therefore the valid first model of the circuit is provided. In step 7 generalization of the true first model is carried out through modification of the same, in order to obtain the second model of the circuit. In step 8 it is checked whether the second model is a true model of the circuit. This can take place, for example, by checking through formal verification whether the second model is valid for the examined circuit. A class of algorithms for achieving this is called “Property Checker”, and as well as the model processes a machine-readable description of the circuit, which for example may be an RTL description in VHDL or another hardware description language.

If in fact it turns out that the second model is not a valid model of the circuit, as indicated by arrow j, modification of the first true model can be repeated, whereby another modification is now performed. In addition or alternatively, as illustrated by arrow k, a transition to step 9 can be made. This means that it is assumed that the model describes the circuit as desired, however the design of the circuit, thus for example the description in the hardware description language, is wrong and consequently an error must be looked for.

If, however, it turns out that the second model is a valid model of the circuit, the second model is generated in step 10 as a model of the circuit for formal verification and stored for example. This is illustrated by arrow i. In addition or alternatively, as illustrated by arrow h, the process can be repeated, whereby the second model then serves as a new valid first model for the next run. Thus the original valid first model can be modified step by step and after each modification can be checked whether the second model is a valid model.

With this step by step procedure the probability of an invalid model arising in an individual step, is slight. Should it turn out that the respective second model is not a valid model, only the last modifications have to be taken into consideration when tracing the cause.

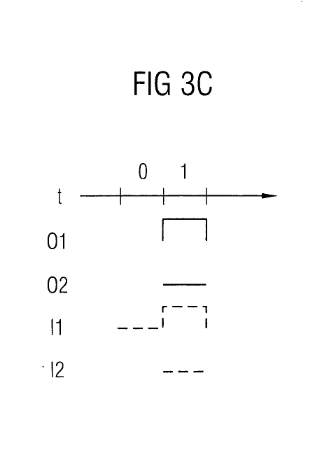

In FIGS. 3A to 3C creating or generalizing a model of a circuit from a simulation, as it can be carried out in step 7, is now illustrated as an example. In this case a graphic user interface is provided, with which modification of the first true model, created from the simulation, can be performed.

In FIG. 3A a simple simulation is shown, as it can be displayed on a screen of the computer system. In this case the time progression of binary signals O1, O2, I1, I2 and S1 is illustrated in time-discrete steps 0 to 20. In this case time point t=0 represents a start time point of the simulation displayed. Signals O1 and O2 are output quantities for example and are illustrated by a continuous line. Signals I1 and I2 represent input quantities and are illustrated by a broken line, signal S1 corresponds to an internal signal of the circuit and is illustrated by a dotted line. Naturally the various signals can also be differentiated, for example by different shades. The various quantities and/or signals of the model are also generally called properties of the model.

From this simulation a first true model can be created automatically. As described in the introduction, a typical model consists of assumptions and assurances. In order to obtain the first valid model, the following categorizations are now performed:
Value curve of all input quantities such as I1, I2 becomes the assumption.
Value curve of all output quantities such as O1, O2 becomes the assurance.
Values of storing capacities, that is to say quantities, which store a specific value at time point t=0 become the assumption. This is necessary, in order to define a specific start state.
Other values of the storing capacities become the assurance.
Values of internal quantities, which are not storing capacities, become the assurance.
Assumptions and assurances are preferably illustrated differently, for example by different shades.

The model obtained in this way for each simulation of the circuit and for any random time point t ensures that whenever the circuit state at time point 0 corresponds to the assumption about the storing capacities, and if the input quantities from time point 0 have the value curve described in the examination window, that the output and internal quantities have the assured value curve. This model is by design valid for the simulated circuit and is an example of a first valid model according to step 6 in FIG. 2.

In order to generalize this first valid model, as shown in FIG. 3B, a time window 11 can firstly be selected. The model in this case is limited to time points 10 and 11. Preferably in this case the values of storing capacities on the left-hand side of the window 11, that is to say at time point t=10, automatically become assumptions.

Since simulations frequently comprise many thousands of steps, it may be expedient to complete the selection of a suitable time window before the conversion of the simulation into a first true model described above.

The selected time points t=10 and t=11 are then renamed t=0 and t=1. It is to be noted that the expression “t=0” is not to be understood as absolute (for example in relation to a system time of the circuit), but relative time statement, that is to say as a starting time point of the time window 11 and/or the model formed in this way.

The graphic representation of this step is clear from the usual graphic representation of a simulation by the value curves of the circuit quantities. The signal progressions outside the time interval 11 selected for the examination window are either faded out or, as in the present example, illustrated differently. It is also possible that both the simulation as in FIG. 3A and the derived model are illustrated in two windows.

A criterion, by which the user can be guided in the selection of the time window, is the desire to describe an operation of the circuit, that is to say a sequence of steps generally belonging together, as for instance the execution of a transaction in a bus interface. The time window is then selected in such a way that the operation is triggered with the first time point and it is completed at the last time point. The operation can thereby be started by a signal transfer of a trigger signal.

For the exemplary execution of the model modifications according to step (b) in FIG. 1 a model is assumed, in which assumptions and assurances are described in a discrete time frame of consecutive time points, the first time point of which is arbitrary and is designated in the following with t=0. Assumption and assurance should in each case be formed by a conjunction of demands in the form “at a time point t=n a signal s has a value w”. Such conjunctions are called atomic facts in the following. The above-described model derived from the simulation satisfies these requirements. The atomic facts are divided into the following categories:
Assumption, if the atomic fact is part of the assumption
Assurance, if the atomic fact is part of the assurance
Irrelevant, if the fact is not to play a role in the model

After dividing the original model into atomic facts, there are at first no irrelevant facts. The model modifications are the result of the user changing the category of individual atomic facts. If for instance an atomic fact of the assumption is changed to an irrelevant fact, the model is generalized, because the assurance is now to apply to more sequences of the circuit. The respective atomic fact, therefore part of the corresponding quantity, is thus removed from the model. The new model can however become invalid as a result, which is checked in step 8 by FIG. 2 through formal verification of the modified model. If an atomic fact of the assurance is changed to an irrelevant fact, the new model describes the sequences of the circuit less precisely. A valid model remains valid as a result nevertheless.

Graphically, the atomic facts can be indicated jointly on a matrix, in the lines of which the individual signals and in the columns of which the time points are removed, so that a diagram as in FIG. 3B again results. The categories of the atomic facts are graphically differentiated, for instance by different shading or facts of the irrelevant category not being represented at all. The alteration of the category of an atomic fact leads to re-shading in the appropriate place. Signals, for which there are only irrelevant atomic facts, play no role in the model and can also be totally removed from the display.

Apart from the alteration of the categorization of individual atomic facts, it can be helpful for the user if he can execute operations, in which case the categorization of several atomic facts is altered at the same time. Such an operation could for instance re-categorize all atomic facts of a signal, so that a signal becomes completely irrelevant and is therefore removed from the model. Also, operations are expedient for reducing the time window 11, in which case all atomic facts are re-arranged at time points outside the new time and/or examination window into the irrelevant category.

It is to be noted that basically changes of the categorization can be made arbitrarily. For example an atomic fact of an input quantity can become an assurance, or an atomic fact of an output quantity an assumption.

If the user would like to describe a circuit operation through the model, he will generally call irrelevant all atomic facts, which do not have anything to do with the circuit operation, or which are uninteresting, because they are derived for instance combinationally from other signals. He will retain assumptions, in which aspects of the function of adjacent circuits, important for the operation being examined, are reproduced. Furthermore, assumptions are retained, which represent an inherent part of the situation under observation (for example the assumption about the activation of the write signal in a model about a write operation of a bus interface).

On the basis of the representation in FIG. 3B the user can for instance decide to describe the circuit behavior, which occurs if the input quantity I1 makes a transfer and after the transfer the input quantity I2 has the value zero. In this case, a specification of the circuit may envisage firm values for example after the transfer of I1 for the output quantities O1 and O2, which are independent of the internal quantity S1. This is represented in the model modification, by all atomic facts of S1 being moved into the irrelevant category and therefore the signal being deleted from the graphic representation. Furthermore, the model is not to make any statements about the values of O1 and O2 before the transfer of I1. Therefore the user likewise moves the corresponding atomic facts into the “irrelevant” category. If irrelevant atomic facts are not displayed, the representation in FIG. 3C results.

The model obtained in this way is automatically checked for its validity through formal verification.

If the modified model proves invalid, that is to say, if it turns out that the modified model does not describe an actual behavior of the circuit, the influence of the last modification is checked. Possibly a design error of the circuit has been traced. Otherwise the last modifications are cancelled and the process is carried on with other modifications.

The simulation described above and the modification options are to be understood as examples. Also further properties of the model can be taken into consideration, for example relations between various signals or limit values for signals. Also extensions are conceivable, in which case an assurance does not have to arise at a specific time, but within a time interval.

In addition, symbolic dependences can be introduced, for example, if the model should include the fact that a signal value is to be computed by way of a specific function from other signal values, for instance with regard to the example from FIG. 3C O1=I1+I2.

Such functions can be entered by a user, for example. In addition, it is however conceivable that such dependences can be extracted by means of corresponding software from a code of the circuit, for example a VHDL code.

Furthermore, it is naturally possible to generate different models from a simulation for example by selecting different time windows or other modifications. For this purpose, it is necessary that different modifications can be stored, at the same time the original simulation and/or the original true model remaining valid.

Similarly, several simulations can also be combined in order to derive a first valid model therefrom. This can for example also bring about further automation, by various simulations being compared automatically and only the agreeing parts being taken into consideration for this model. The various simulations or various models can in this case be displayed on a screen in different windows.

Such a method for creating models can be used in a variety of different scenarios, for example:
“Top Down” verification, in which case the models are created and checked before the implementation phase if the HDL code is present (for this purpose another source would be needed for the true property, which is used as the start point),
“Bottom Up” verification, in which case a model is created, when the HDL code is present and simulation results can be used (here the models serve to debug the HDL code).

So-named “Reverse engineering”, in which case an HDL code is present, the exact specification of which is not known. Then this code can be analyzed by checking hypothetical models.

1. A method for creating a model of a circuit for the formal verification of the circuit, whereby the model describes a behavior of the circuit, comprising the steps of:
a) providing a valid first model, which describes an actual behavior of the circuit,
b) generating a second model of the circuit based upon the first valid data model, and
c) determining whether the second model is a valid model of the circuit, whereby the second model is recognized as a valid model of the circuit if the second model describes an actual behavior of the circuit.

2. Method according to claim 1, whereby the valid first model describes a behavior of the circuit during a specific period.

3. Method according to claim 2, whereby the valid first model describes a behavior of the circuit in discrete time steps.

4. Method according to claim 2, whereby the specific period is limited in step (b) for modification of the valid first model.

5. Method according to claim 1, whereby properties of the valid first model are divided into categories of assumptions, which represent pre-conditions for the behavior described by the second model, categories of assurances, which represent a result of the behavior described by the second model resulting from the assumptions, and into categories of irrelevant properties, which are irrelevant for the behavior described.

6. Method according to claim 5, whereby the category of at least one property of the true first model is changed in step (b) for generalizing the true first model.

7. Method according to claim 2 and claim 5, whereby the properties of the first model comprise storage capacities whereby the values of these storage capacities are categorized as assumptions at the start of the specific period.

8. Method according to claim 2 and claim 5, whereby the category of at least one property of the first model comprises at least at one time point in step (b) for generalizing the true first model.

9. Method according to claim 1, whereby properties of the valid first model comprise at least one quantity of the group consisting of input quantities, output quantities and internal quantities of the circuit.

10. Method according to claim 5 and claim 9, whereby the input quantities of the first model are categorized as assumptions and the output quantities of the first model as assurances.

11. Method according to claim 10, whereby a symbolic dependence between the quantities is defined in step (b).

12. Method according to claim 11, whereby the symbolic dependence from a description of the circuit is determined automatically.

13. Method according to claim 11, whereby the symbolic dependence is defined by a user.

14. Method according to claim 1, whereby the second model is recognized as a valid model in step (c), if a formal verification of the second model shows that it relates to a valid model.

15. Method according to claim 1, whereby the valid first model provided in step (a) is determined by a simulation of the circuit.

16. Method according to claim 1, whereby the valid first model provided in step (a) is determined by a combination of several simulations.

17. Method according to claim 1, whereby step (b) is controlled by a user input.

18. Method according to claim 1, whereby a graphic representation of the valid first model or the second model takes place.

19. Method according to claim 5 and claim 18, whereby various categories of properties of the particular model are illustrated differently.

20. Method according to claim 17 and claim 18, whereby the valid first model is modified in step (b) by graphic editing of the graphic representation of the true first model by a user input.

21. Method according to claim 1, whereby step (c) is carried out automatically.

22. Method according to claim 1, whereby the execution of the method is computer-aided.

23. Method according to claim 1, whereby after step (c) the method according to claim 1 is repeated with the second model as a valid first model, if it was found previously in step (c) that the second model is a-valid model.

24. Method according to claim 1, whereby after step (c) the method according to claim 1 is repeated with the same valid first model, whereby at the time of repeated execution of the method in step (b) another modification of the true first model is performed, if it was found previously in step (c) that the second model is not a valid model of the circuit.

25. Method for the formal verification of a circuit by means of a model of the circuit, whereby the model is created by a method according to claim 1.

26. Device for creating a model of a circuit for the formal verification of the circuit, comprising
a first apparatus for providing a valid first model,
a second apparatus for generalizing the valid first model by modification of the valid first model, in order to obtain a second model of the circuit, and
a third apparatus for checking whether the second model is a valid model of the circuit, whereby the third apparatus is configured in such a way that it recognizes the second model as a true model of the circuit, if the second model describes an actual behavior of the circuit.

27. Device according to claim 26, whereby said first apparatus and said second apparatus comprise program code.

28. The device according to claim 27 wherein said program code comprises an electronically readable data medium with electronically readable control signals stored on the data medium, which are such that if the data medium is used in a computer system the method is implemented according to any one of claims 1 to 25.
